(19) United States
(12) Patent Application Publication
(10) Pub. No.: US 2012/0062871 A1
(43) Pub. Date: Mar. 15, 2012

(54) METHOD AND SYSTEM FOR THE MEASUREMENT/DETECTION OF CHEMICAL SPILLAGE

(75) Inventor: Renato Bugge, Trondheim (NO)

(73) Assignee: INTEGRATED OPTOELECTRONICS AS, Trondheim (NO)

(21) Appl. No.: 13/255,946

(22) PCT Filed: Mar. 12, 2010
(86) PCT No.: PCT/NO2010/000094

§ 371 Date: Nov. 21, 2011

(30) Foreign Application Priority Data
Mar. 12, 2009 (NO) NO20091090

(51) Int. Cl. G01N 21/55; G01J 3/00; G01N 21/47

(52) U.S. Cl. 356/51; 356/446; 356/445

(57) ABSTRACT

The invention relates to measurement of chemical spillage, such as oil spillage, by the use of one or more IR-lasers, necessary optics and optical sensors. The measurements are performed by reflecting the emitted light from the laser(s) back from the chemical and registered by optical sensors. To accurately detecting the chemical the system utilizes at least three different wavelengths which are emitted from one or more lasers. The wavelengths are chosen so that the reflection from the chemical is different for at least three of these, and that it can be distinguished from the background.

The invention relates to the measurement of chemical spillage, by using one or more IR-lasers, necessary optics and optical sensors. The measurement is performed by that the emitted light from the laser(s) is reflected by the chemical and registered by optical sensors. To be able to detect the chemical, the system is using at least three different wavelengths, which are emitted from one or more lasers. The wavelengths are chosen such that the reflection from the chemical is different for at least three of these, and that it can be distinguished from the background. A chemical which can be detected is oil, where especially oil spillage on water is possible to distinguish from water without oil spillage, preferably within the wavelength range 1-10 μm.

The technique can also be used to form a spatial image of the spillage and/or depth information of the spillage by mapping an image of reflected light in one or more axes, and/or by moving the laser within the same area.

In connection with moving water, the technique can be used to see specular reflections, and/or diffuse reflections from the surface of the water. One can thus use it in a warning system for chemical and/or oil spillage on water. The same method will also be suitable for detecting chemical and/or oil spillage onshore.

The invention relates accordingly a method according to the preamble of claim 1 and a system for carrying out the method according to the preamble of claim 14.

### BACKGROUND

Presently, different methods are being used for detecting and measuring oil, among others radar measurements and waste gas measurements of the spillage. One of the applications for this is surveillance of unloading of oil where it is important to detect possible leakages at an early stage. Equipments being used for this today often have weaknesses in that they are not accurate enough for the relevant environments. Among others, a lot of oil unloading is performed on ships, and often in weather conditions which is a challenge. In practice present equipment result in many false alarms which results in that the operators often turn off the measuring equipment, and with the subsequent risk for large spillage.

US2009039255A describes an invention for the detection of oil spillage by the use of an optical method. US2009039255A take basis in that one under certain circumstances has thermal and atmospheric infrared radiation. The reflected background and the thermal emission from the oil spillage is thought to be a source for the infrared light and one shall watch the difference between water and water with oil by collecting this light. US2009039255A is thus based on that a certain amount of infrared light is available from the environments, and will in practice get problems when that is not the case.

From US2007210262A it is known an apparatus for measuring hydrocarbons, such as oil, fuel and similar. It is used a lamp-like light source which must be filtrated to remove undesired wavelengths of the light. US2007210262A has the disadvantage that it does not have the possibility to scan the wavelength, and one must thus take basis in a fixed wavelength band.

US2007102333A describes a method for optical detection of oil spillage on a surface by using two wavelengths from an optical “echo”. The method describes no light source, but that the optical “echo” should come from an optical radiation in the measure area. Thermal radiation can be such radiation, and “echo” can be from thermal radiation which is scattered by oil spillage on the water.

In US2004257264A it is described a system which measures oil spillage by the use of radar in the microwave band (over 30 cm wavelength, ref. International Electrotechnical Commission). US2004257264A also describes wavelength of the source as a microwave radiometer.

US2003072004A describes a method for measuring oil spillage by measuring the interference pattern of oil drops on a surface. The method is thus not suitable for measuring oil films, but only for cases where the oil is as singular drops. The method in US2003072004A will not be able to distinguish between different chemical objects, and round objects of other materials could also scatter the light in a similar way.

US20041300713A describes a method which uses atmospheric reflection to measure the content of a chemical in water. It is described a method based on absorption of the water, which therefore means that it is used optical radiation which pass a certain length through water before it is reflected back to the instrument.

In U.S. Pat. No. 5,296,711A it is described a method for measuring oil spillage on water by the use of ultraviolet laser light. The method is based on Raman measurements of back-scattered light for finding chemical information.

From U.S. Pat. No. 5,281,826A, U.S. Pat. No. 3,899,213A, U.S. Pat. No. 3,806,727A and GB2129125A1 it is known fluorescence based systems for measuring spill of fluids with fluorescence properties, something which makes them dependent of fluorescence from a chemical to provide measurements.

U.S. Pat. No. 4,517,458A describes a method for measuring hydrocarbon spillage where one is analyzing aerosols in the air over this by using a laser. The method is thus based on gas absorptions.

From U.S. Pat. No. 3,783,284A it is known a system for detection of petroleum products in an area with water. It is used a broadbanded optical source (lamp or heating element) with two fixed optical filters, something which results in that it only can be measured at two wavelengths, which results in a reduced amount of data and a poor signal/noise ratio.

### Object

The object of the invention is to provide a novel method and system for measuring and detecting chemicals, such as oil, from a given distance with infrared light. The method is suitable for detecting chemical spillage, such as oil spillage, offshore, onshore or on stationary installations. It is also an object of the invention to provide a solution which improves the disadvantages of prior art and which provides a more accurate result than prior art solutions.

### The Invention

A method according to the invention is described in claim 1. Preferable features of the method are described in claims 2-13.

A system according to the invention is described in claim 14. Preferable features of the system are described in claims 15-29.

The present invention discloses a system which directly measures chemical and/or oil by considering reflected infrared light on three or more wavelengths. The system utilizes either one or more tunable lasers or several single lasers, preferably in the infrared range 1-10 μm. The radiation from the laser is utilized to measure one or more chemicals, where the response is given by which wavelengths the actual chemical reflects or absorbs. This response will be different from chemical to chemical, such that the system compares the different measuring points with a reference library to recognize the actual chemical. One thus gets a system which only provides a positive detection of a chemical if this is physically present at the reflecting surface.

The system can compare reflections from the surface/chemical with prior collected data to consider changes in reflection. This increases the accuracy of the system by that it is capable of considering minor differences in the reflection from a surface.

In comparison, radar based warning system for chemical spillage, such as oil spillage, uses reflected radio waves from water. The reflection in radio waves changes as a result of that the waves in the water changes characteristics. Such a system considers macroscopic changes at the water surface, in contradiction with the present system which considers changes in reflection of the fluid (water, chemical or oil) itself on basis of absorption of the chemical bonds in the different fluids. A radar based system will not be able to see this as the wavelengths exceed what is needed for the excitation of chemical bonds.

To provide a laser based system for remote measurement and detection of chemicals, such as oil, one collects spectral information from several wavelengths by either tuning an infrared laser and/or by using several fixed or tunable infrared lasers. The object is to acquire the amount of data points being necessary for recognizing the chemical in question.

The laser is focused or collimated, and next emitted against the point(s) desired to search. The surface which is hit by the laser light will emit a specular reflected and diffused reflected light, where some of this is emitted towards a receiver. The receiver can be provided with one or more lenses and/or mirrors for increasing the signal amount which the receiver registers. The system can have different embodiments for registering this reflected light:
1. The laser(s) and receiver are arranged close to each other so that the system registers light which is reflected straight back or close this.
2. The laser(s) and receiver(s) are arranged in different positions. Light being reflected from the surface will hit one or more of the receiver(s).
3. The optical system is aligned with a beam splitter so that emitted laser light and the measured light in follows the same path, but in the opposite direction.

The different solutions can be implemented so that laser and/or receiver can be moved for focusing, emitting or collecting light within an area.

A method for the measurement/detection of chemical spillage, such as oil spillage, in a defined area in the vicinity of an object onshore, offshore or in the air, can be summarized in the following steps:

a) tuning of the wavelength of a tunable laser by means of electrical and/or thermal control, and/or utilizing one or more fixed or tunable lasers,

b) illumination of the defined area to be searched,

c) measuring and registering of specular reflected and diffused light signal from the surface of the defined area by means of a receiver,

d) collecting and storing measurements in a control device,

e) analyzing the measurements by means of a control device or an external unit,

f) detecting a chemical by means of one or more reference libraries or algorithms arranged in the control device.

The method may further include forming a spatial image of the chemical spillage and/or depth information on the chemical spillage by mapping an image of reflected light in one or two axes, and/or moving the tunable laser source within the same area.

Results from the method can further be used in a warning system for chemical and/or oil spillage in the defined area, offshore or onshore.

The method can be used by objects moving offshore, onshore or in the air.

The present invention is distinguished from US2009039255A in that a laser source is not being used in US2009039255A but one takes basis in that one under certain circumstances have thermal and atmospheric infrared radiation. The reflected background and the thermal emission of the oil spillage is thought to be a source for the infrared light and one can consider the differences of water and water with oil by collecting this light. US2009039255A is thus based on that a certain amount of infrared light is available from the environments, and will in practice get problems when this is not the case. The present invention does not need such a thermal background, and can thus work independent of the environment submit low or high thermal or atmospheric radiation. As the signal level of the reflection also is proven to be low, one will with the present system be able to increase the signal/noise ratio by increasing the power of the laser (intensity of laser light), and pulse filtration of this laser light. The present invention is thus more robust than US2009039255A.

The present invention is distinguished from US2007210262A in that it in US2007210262A is used a high-power lamp-like light source which must be filtrated for removing undesired wavelengths of the light. The present invention does not use such optical filters since a laser source only emits a given wavelength. In the present invention the laser(s) is/are tuned in wavelength to increase the amount of collected data. US2007210262A does not have the opportunity to tune the wavelength and must thus take basis in a fixed wavelength band. As the signal/noise ratio is low it is important to increase the amount of data points from the measurement. In the present invention this is achieved by tuning the laser(s) over several wavelengths and collecting data from each wavelength, something which makes the accuracy of the present invention higher than for the system described in US2007210262A.

The present invention differs from US2007102333A in that the method in US2007102333A does not describe a light source, but that the optical “echo” should come from optical radiation from the measured area. Thermal radiation can be such radiation, and “echo” can be thermal radiation which is scattered by oil spillage on the water. The present invention distinguishes in that the measured optical radiation does not come from the chemical, but is reflected laser light through specular reflection or diffuse reflection. In the present invention it is also used more than two wavelengths as one tunes the laser to increase the amount of data, which is not an object of the invention in US2007102333A.

The present invention is distinguished from US20041300713A in that the present invention utilizes a laser source for the light and does not use atmospheric radiation. The method in the present invention is based on considering differences between reflections from an oil film which lies on water, and not on a chemical dissolved in the water, especially by that the present invention utilizes optical radiation in the range 1 μm to 10 μm which only goes a few millimeters in water, and is thus not suitable for measuring water absorption.

The present invention is distinguished from U.S. Pat. No. 3,783,284A in that it in U.S. Pat. No. 3,783,284A is used a broadbanded optical source (lamp or heating element) with two optical filters, whereas the present invention utilizes a laser which can change wavelength. U.S. Pat. No. 3,783,284A measures therefore only two wavelengths, while the present invention utilizes three or more wavelengths to increase the amount of collected data and improve the signal/noise ratio.

It is thus obvious that the present invention exhibits improved accuracy/reliability over prior systems through increased amount of collected data and an improved signal/noise ratio.

Further preferable features and embodiments of the invention will appear from the following example description.

### EXAMPLE

The invention will below be described in detail with reference to the attached drawings, wherein

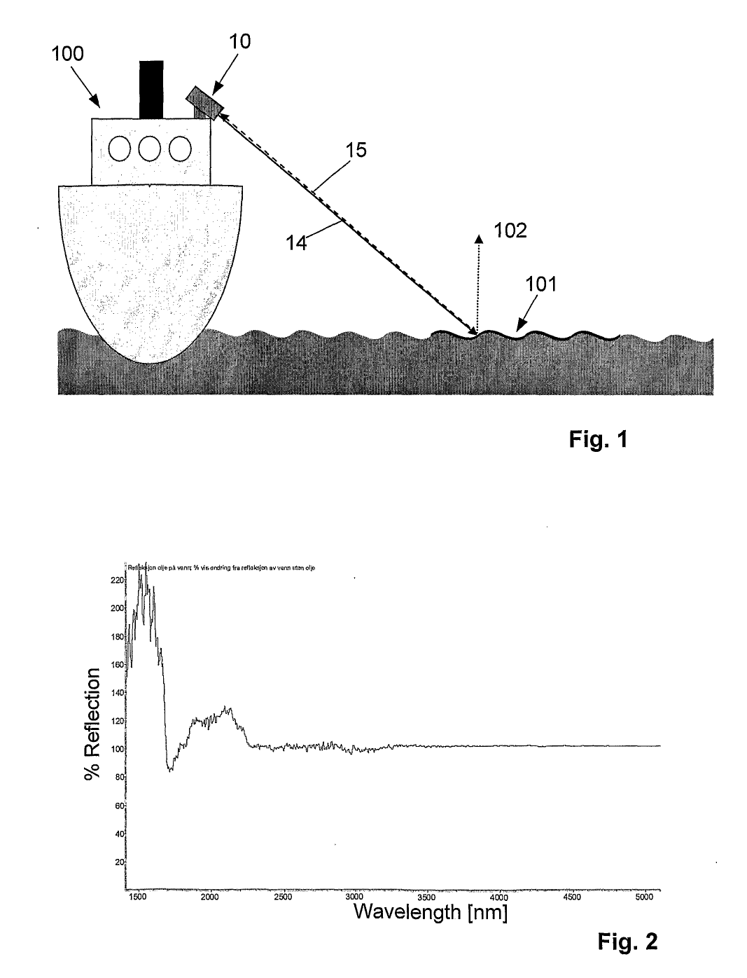

FIG. 1 shows the use of a measuring system according to the invention arranged on an object offshore,

FIG. 2 is an example of infrared light reflection of oil on water,

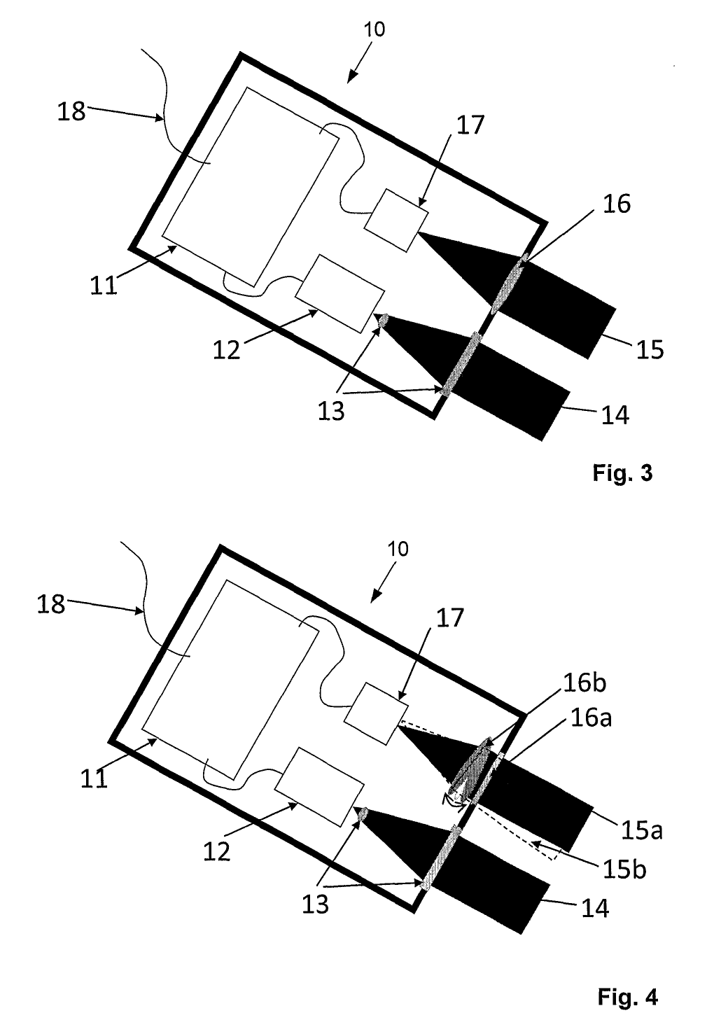

FIG. 3 is a sketch of a measuring system according to the invention for detection of oil and/or chemicals on water,

FIG. 4 is an alternative embodiment of the system in FIG. 3,

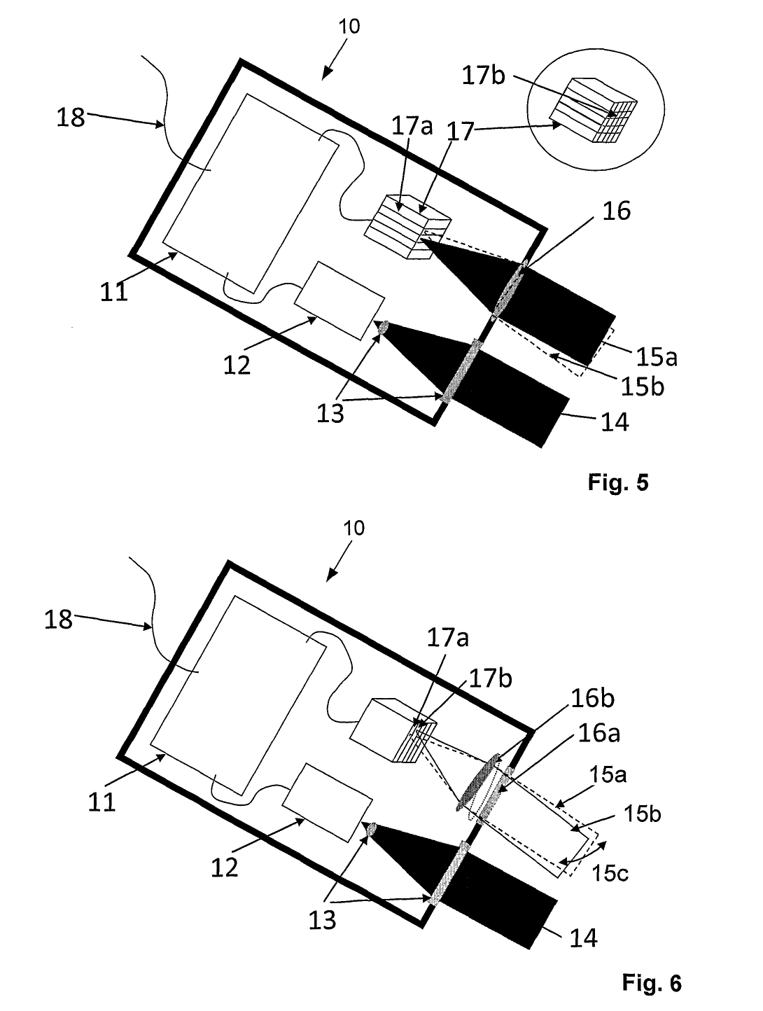

FIG. 5 is another embodiment of the system in FIG. 3,

FIG. 6 is another embodiment of the system in FIG. 4,

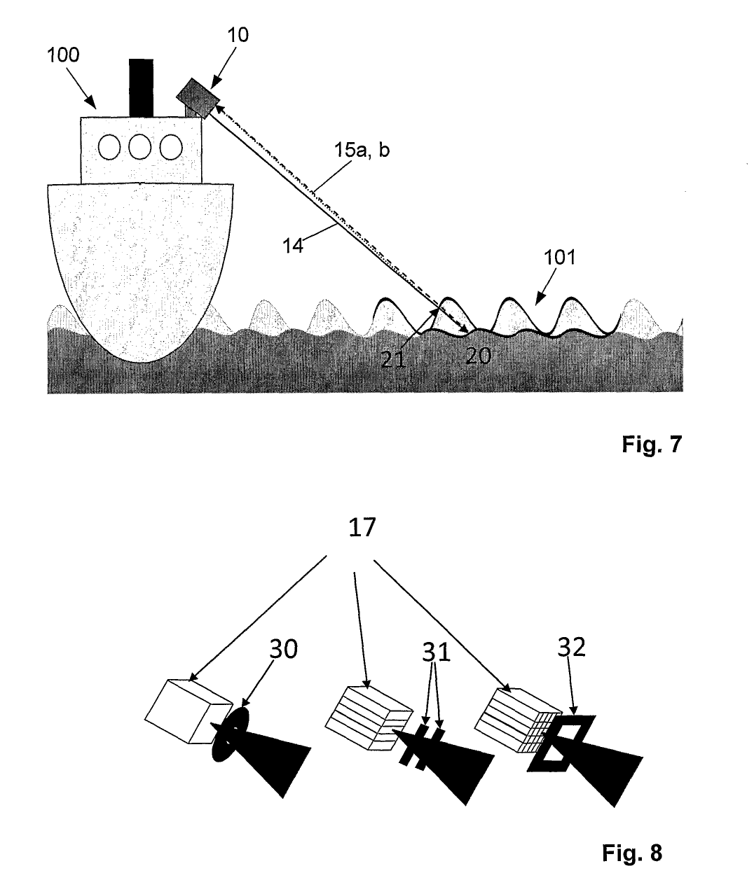

FIG. 7 is an alternative solution to the embodiment shown in FIG. 1 by the use of different system embodiments, such as shown in FIG. 4, 5 or 6,

FIG. 8 is an alternative embodiment of a light meter in the systems of FIG. 3-6 or 10,

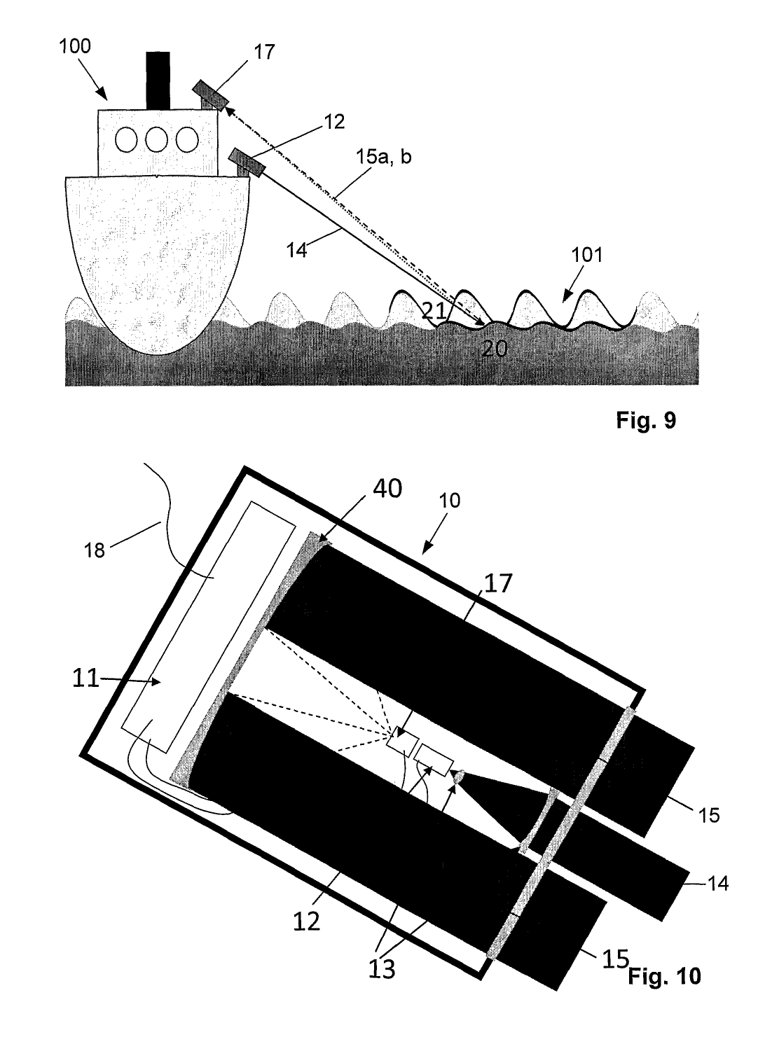

FIG. 9 is an alternative solution of the embodiments as shown in FIGS. 1 and 7,

FIG. 10 is an alternative embodiment of the system of FIGS. 3-6,

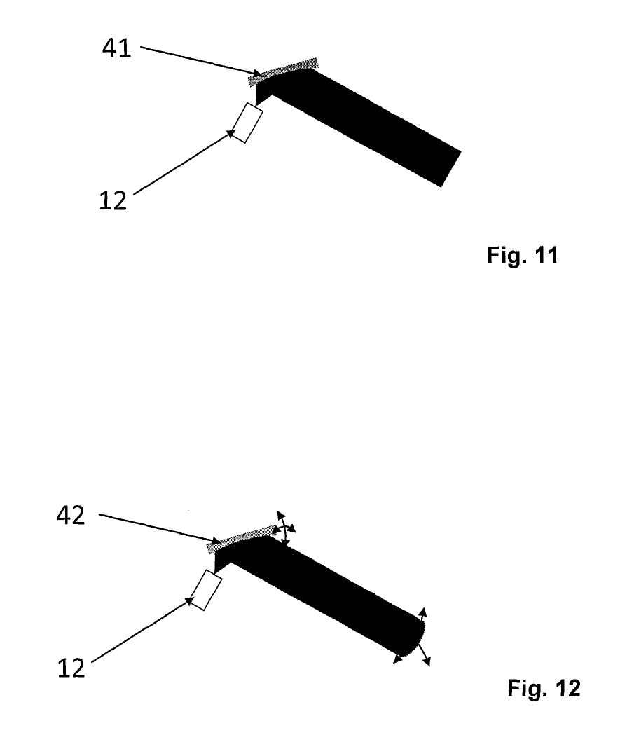

FIG. 11 is an alternative embodiment for collimation of the laser for the system of FIGS. 3-6 and 10,

FIG. 12 is an alternative embodiment for collimation of the laser of FIG. 11,

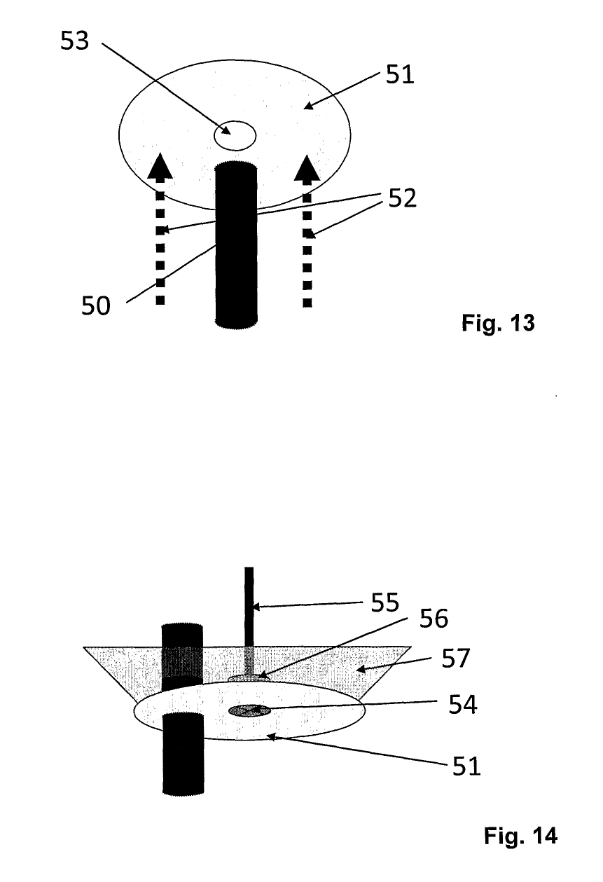

FIG. 13 is an alternative embodiment of systems and embodiments of FIGS. 1-12,

FIG. 14 is an alternative embodiment of embodiments of a rotating window of FIG. 13, and

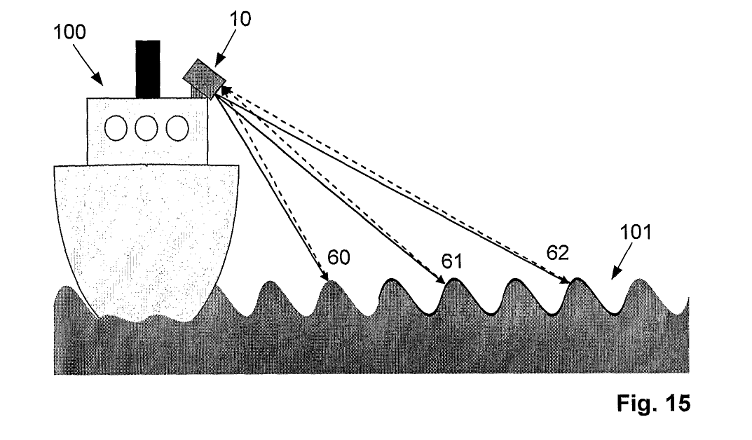

FIG. 15 is an alternative solution of the embodiments as shown in FIG. 7 by using a tiltable laser in one or more axes.

Reference is now made to FIG. 1 which shows the application principle of a system 10 according to the invention, arranged on an object 100, such as a floating vessel in the sea 101. The system 10 is arranged to emit one or more laser beams 14 (solid line) which is reflected 15 (dotted line) by oil and/or chemicals on the sea 101 back to the system for measurement and registration. The system 10 is in principle not arranged for registration of light reflected or scattered in other directions 102.

FIG. 2 shows an example of infrared light reflection by oil on water, shown as % light reflection from water without oil as reference (100%). One can see that there arise three clear prints which can be recognized:

1) increased reflection to >150% at wavelengths of 1.4-1.7 μm.

2) reduced reflection in the range 1.7-1.8 μm.

3) increased reflection to 110-130% in the range 1.9-2.2 μm.

Reference is now made to FIG. 3 which shows a sketch of a system 10 according to the invention for the measurement/detection of oil and/or chemicals on sea 101, and recognizing of type of chemical. The system includes an electronic control device 11 which controls a tunable laser 12. The laser light optionally utilizes collimating optics 13 to provide a collimated laser beam 14 which emits from the system. The reflected light 15 which comes back to the system is collected by focusing optics 16 which focus the light down on a receiver in the form of a light meter 17. The signal from the light meter 17 is transferred to the electronic control device 11 which process the measurements and register results, and performs recognition of the type of chemical. For the recognition of type of chemical the control device 11 is provided with one or more reference libraries and/or algorithms for this. The result is possibly sent to an external panel or surveillance equipment 18 which performs recognition and storing/logging, and warning of chemical spillage.

FIG. 4 shows an alternative embodiment of the system 10 of FIG. 3. Focusing optics 16 of FIG. 3 is replaced with an optical window or filter 16a and adjustable focusing optics 16b. The optical light meter 17 receives the light from different positions of the focusing optics 16b, which thus enters from different entrance angles for incoming light 15a and 15b. If necessary the light meter 17 will be arranged movable with the focal point of the optics 16a and 16b. The advantage of this embodiment over the embodiment of FIG. 3 is that one can see reflections from different distances from the system, dependent on the angle of the focusing optics 16b.

Reference is now made to FIG. 5 which shows an alternative embodiment of the system 10 of FIG. 3. Focusing optics 16a-b receive reflected laser light, but the optical light meter 17 is replaced with a series (1-dimensional) 17a or a grid (2-dimensional) 17b of optical light meters, such that light which enters from different angles 15b than the light 15a which was measured in FIG. 3 also is registered. The advantage with this embodiment compared to the embodiment of FIG. 3 is that one can see reflections from different distances from the system, dependent on the incoming light 15a, 15b.

FIG. 6 shows an alternative embodiment of the system 10 of FIG. 4. The optical light meter 17 of FIG. 4 is replaced with a series of light meters (1-dimensional) 17a, 17b, etc. The focusing optics 16b can be adjusted along one axis, such as in FIG. 4, but will in addition be able to measure light along one axis perpendicular to this. The Figure shows how light from different angles of incidence for a given position of the focusable optics 16b, will be focused to different light meters 17a, 17b, etc. By using adjustable optics 16b and several light meters 17a, 17b, etc., reflected light with different angles of incidence along two axes can thus be measured. The advantage of this solution compared to FIG. 4 is that inaccuracies in the optical alignment of the system can be corrected by maximizing reflected signal.

Reference is now made to FIG. 7 which shows an alternative solution of the embodiment of FIG. 1, by the use of different system embodiments 10, such as shown in FIG. 4, 5 or 6. The Figure shows a situation where different wave heights 20 and 21 affect how far away the system the reflection is coming from. This again provides different reflected angle of incidence of the light. The alternative embodiments of FIGS. 4, 5 and 6 will thus more often collect reflections than a system which only focuses on one point.

FIG. 8 shows an alternative embodiment of a receiver, i.e. light meter 17, of the system 10 of FIG. 3-6 or 10. To reduce the noise and increase the signal/noise ratio it is used one or more apertures 30, 31 or 32 in front of the light meter 17. The aperture 30-32 should be adjusted so that only light from there the laser can hit, contributes to the measured light. The advantage of this solution compared to FIGS. 4 and 5 is that inaccuracies in the alignment of the system can be corrected by maximizing the reflected signal. The advantage of this solution compared to FIGS. 4-6 is that one can limit the light which hits the detector from other sources to increase the signal/noise ratio.

Reference is now made to FIG. 9 which shows an alternative solution of the embodiment of FIGS. 1 and 7 in that the laser 12 and the receiver 17, i.e. light meter, are arranged in two different encapsulations. The different system embodiments of FIGS. 3-6 may all be divided so that the laser 12 and receiver 17, i.e. light meter, are positioned separately if they are connected electronically. The light meter 17 must still be arranged so that it can observe reflected laser light from different wave heights 20 and 21.

FIG. 10 shows an alternative embodiment of the system of FIGS. 3-6. In the same way as for the other solutions, the system 10 has an electronic control device 11 which controls a tunable laser 12. The laser light 14 utilizes possibly collimated optics 13 to provide a collimated laser beam which is emitted from the measuring system 10. In contradiction to the other solutions the reflected light 15 is collected by a focusing mirror 40, so that it hits the receiver 17, i.e. light meter. Different embodiments of the receiver 17, i.e. light meter, such as of FIG. 8 may possibly be used to increase the signal/noise ratio. Solutions where the light meter 17 is replaced by a series of (1-dimensional) or a grid (2-dimensional) with optical light meters 17a, 17b could be used in the same way as in FIG. 5. Other solutions where the focusing optics 40 is replaced by adjustable focusing optics 16a, 16b will work in the same way as the examples of FIGS. 4 and 6. The advantages with this solution compared to the solutions in FIGS. 3-8 is that a mirror provides less absorption loss than lenses and that one therefore lose less light.

FIG. 11 shows an alternative embodiment for the collimation of the laser 12 for the measuring systems 10 of FIGS. 3-6 and 10. The tunable laser 12 is collimated by means of an elliptic mirror 41. The advantages of this solution over the solutions of FIGS. 3-8 are that a mirror results in less absorption loss than lenses and that one thus lose less light.

FIG. 12 shows an alternative embodiment for the collimation of the laser 12 as shown in FIG. 11. The tunable laser 12 is collimated by an elliptic mirror 42 which can be tilted in one or two axes. This provides opportunities for a scan along the actual axes, so that one in combination with the measuring systems 10 of FIGS. 1-10 to a larger extent will be able to adjust the laser 12 so that the reflection 15 can be maximized for a given angle of departure of the laser. This also provides the opportunity to map an area for oil and/or chemicals.

Reference is now made to FIG. 13 which shows an alternative embodiment of the systems and embodiments of FIGS. 1-12. The system is enclosed (not shown) and a rotating window 51 is arranged so that the laser beams 50 out of the window and the reflected radiation 52 in the window pass through this. Fixed optical elements which are parts of the encapsulation (not shown) is either removed (if unnecessary) or moved inside the encapsulation. The rotating window 51 prevents that water, ice and dirt obstruct the light which is transmitted through it. The window 51 is optionally mounted via a shaft 53 or a bearing around the entire window 51 and connected to an electric motor (not shown) which drives it around.

FIG. 14 shows an alternative embodiment for design of the rotating window 51 of FIG. 13. The window 51 is connected to one or more polar magnets 54 which are run by magnetic transfer of rotation. A drive shaft 55 is connected to polar magnets 56 which transfer the force to the rotating window 51. Between the two sets of magnets 54 and 56 is arranged a window 57 which hermetically closes the interior (drive shaft 55, motor (not shown), optics (not shown) and similar) against the exterior (rotating window 51, etc.). The windows 51 and 57 are transparent to the laser light being used. The advantage with this solution compared to the solution of FIG. 13 is that the sealing against the rotating window does not deteriorate the sealing of the encapsulation, something which, among other things, is important to EX secure systems.

Reference is now made to FIG. 15 which describes an alternative solution of the embodiment of FIG. 7 by use of a tiltable laser in one or more axes. The optics of the reflected light is tiltable within the same axes, so that the system 10 finds one angle for reflectance maxima for each departure angle of the laser beam 60, 61 and 62. By mapping an area the system will acquire information on oil/chemical spillage on the water 61 and 62, and present this as an image of the spread of the oil/chemical spillage.

### Modifications

The system can be modified by using several lasers, tunable or fixed, for the collection of reflection data.

The system can increase the signal/noise ratio by making several subsequent measurements which provides time-averaged reflection data. This increases the time it takes before the system reacts but with more accuracy.

The system can use a pulsed laser source to reduce the signal/noise ratio by that the signal from the optical detector is pulse filtrated electronically or with a lock-in-amplifier.

The system can be provided with a narrow banded optical filter in front of the detector for reducing infrared radiation from background, atmosphere and/or sun.

The system can be provided with an aperture for reducing scattered light from other sources which is hitting the detector.

The system can utilize tiltable lenses and other optics for direction control of the laser beam out of the system.

The system can utilize tiltable elliptic mirrors for the measurement of incoming light in different directions.

The system can utilize temperature control of detector and/or laser to increase the accuracy of the signals and measurements.

The system can be provided with a diffractive grating or prism for frequency filtration of the light coming back on the detector, with the purpose of reducing infrared radiation from background, atmosphere and/or sun.

The system can be provided with one or more optical stabilizers for counteracting movements of structural components the system is arranged on.

The system can be provided with heat in lenses, windows or other components which are exposed to ice formation during use.

The system can be connected to a wireless sender/receiver for wireless communication and transfer of data.

The system can utilize a data processing unit with information from direction dependent recording for forming an image over the area which is exposed for oil and/or chemical spillage.

The system can be provided with an anti-adhesion coating on lenses, mirrors and/or windows for reducing dirt and collection of dust and similar on these.

The system can be provided with a direction control and a control device for aligning the system towards points/areas for monitoring of these, and/or forming an image by recording data from different directions.

The system can be provided with enlarging or decreasing optics for image creation with different optical enlargement.

The system can be provided with a rotating surface, or spherical, parabolic or elliptical mirrors for scanning emitting and incoming light in one or more axes.

1. Method for the measurement/detection of chemical spillage, such as oil, in a defined area in the vicinity of an object onshore, offshore or in the air, which object is provided with a system for the measurement/detection of chemical spillage, and recognition of type of chemical, characterized in that the method includes the following steps:
a) tuning of wavelength of a tunable laser by means of electrical and/or thermal control; by utilizing one or more tunable laser and/or utilizing a pulsed laser source,
b) illuminating of the defined area to be searched,
c) measuring and registering specular reflected and/or diffused reflected light signal from the surface of the defined area by means of a receiver, such as an optical detector or light meter,
d) collecting and storing measurements in a control device,
e) analyzing the measurements by means of a control device or an external unit,
f) detecting a chemical by means of one or more reference libraries and/or algorithms arranged in the control device or the external device.

2. Method according to claim 1, characterized in that the method includes utilizing at least three wavelengths which are emitted from a tunable infrared laser, several fixed or tunable lasers and/or a pulsed laser source, which wavelengths are chosen such a way that the reflection from the chemical is different for at least three of these, and that it can be distinguished from the background.

3. Method according to claim 1, characterized in that the method includes focusing or collimating the laser by means of collimating optics and/or mirrors.

4. Method according to claim 1, characterized in that the method includes moving the laser(s) and/or receiver(s) for focusing, emitting or collecting light within an area.

5. Method according to claim 1, characterized in that the method further includes utilizing:
a narrow-banded optical filter in front of the receiver for reducing radiation from background, atmosphere and/or sun,
an aperture for reducing scattered light from other sources which hit the receiver, and/or
a diffractive grating or prism for frequency filtering infrared radiation from background, atmosphere and/or sun.

6. Method according to claim 1, characterized in that the method includes creating a spatial image of the chemical spillage and/or depth information on the chemical spillage by mapping an image of reflected light in one or two axes, and/or moving the tunable laser source within the same area.

7. Method according to claim 1, characterized in that in connection with movable background in the defined area, such as moving water, the method is arranged for considering specular reflections and/or diffuse reflections from the surface against the background.

8. Method according to claim 1, characterized in that the method includes:
splitting and/or scanning a light signal from the laser to illuminate a larger area, and/or
utilizing movable lenses or other optics for direction control of the laser beam emitting the system.

9. Method according to claim 2, characterized in that the method includes utilizing laser light within the wavelength range 1-10 μm, within the wavelength range 1.4-4.5 μm or within the wavelength range 1.7-3.5 μm.

10. Method according to claim 1, characterized in that the method includes utilizing enlarging or decreasing optics for image creation with different optical enlargement.

11. Method according to claim 1, characterized in that the method includes utilizing a rotating surface, or spherical, parabolic or elliptic mirror for scanning emitting or incoming light in one or two axes.

12. Method according to claim 1, characterized in that the method includes comparing the reflection from the surface/chemical with prior collected data for considering changes in reflection for increasing the accuracy of the system.

13. Method according to claim 1, characterized in that the method includes utilizing results in a warning system for chemical and/or oil spillage in the defined area.

14. System for the measurement/detection of chemical spillage, such as oil, in a defined area in the vicinity of an object (100), onshore, offshore or in the air, and recognition of type of type of chemical, to which object (100) the system is arranged, characterized in that the system (10) includes:
a tunable laser (12),
several fixed or tunable lasers (12), and/or
a pulsed laser source (12) for emitting light of different wavelength towards the defined area, and
one or more receivers (17) for measuring reflected and/or diffused reflected light signal from a surface of the defined area.

15. System according to claim 14, characterized in that the laser(s) (12) and receiver(s) (17) are arranged in a common encapsulation or two different encapsulations if they are connected electronically.

16. System according to claims 14-15 characterized in that
the laser(s) (12) and receiver(s) (17) are arranged close to each other so that the system registers light which is reflected straight back or close to this, or
the laser(s) (12) and receiver(s) (17) are arranged in different positions, so that light being reflected from the surface will hit one or more of the receivers (17).

17. System according to claim 14, characterized in that the tunable laser based light source(s) (12) is/are a tunable infrared laser.

18. System according to claim 14, characterized in that the receiver (17) is a light meter or an optical detector, which receiver (17) is provided with:
focusing optics (16), which is focusing the light to the receiver (17),
an optical window or filter (16a) and adjustable focusing optics (17) for focusing light from different angles of incidence (15a, 15b) to the receiver (17),
a focusing mirror (40) for collection of reflected light (15) for the receiver (17),
a narrow-banded optical filter for reducing infrared radiation from background, atmosphere and/or sun, and/or
a diffractive grating or prism for frequency filtration of the light which comes back on the receiver, for reducing infrared radiation from background, atmosphere and/or sun.

19. System according to claim 18, characterized in that the receiver (17) is arranged movable to be moved with the focal point of the optics (16a, 16b).

20. System according to claim 18, characterized in that the receiver (17) is formed by a series of light meters (17a, 17b, etc.) (1-dimensional) for measuring reflected light with different angles of incidence along two axes.

21. System according to claim 14, characterized in that the system includes one or more apertures (30-32) for reducing the signal/noise ratio, which apertures (30-32) are arranged in front of the receiver (17).

22. System according to claim 14, characterized in that the system includes collimating optics (13) for providing a collimated laser beam (14) emitting from the system.

23. System according to claim 14, characterized in that the system includes an elliptical mirror (42), which can be moved in one or more axes, for directional control of the collimated laser (12) which either is fixed or tilted together with the mirror.

24. System according to claim 14, characterized in that the laser(s) (12) and/or receiver(s) (17) are arranged movable for focusing, emitting or collecting light within an area.

25. System according to claim 14, characterized in that the system includes:
a computer processing unit with the information from a direction controlled recording for creating an image over the area being exposed for oil and/or chemical spillage,
one or more optical stabilizers for counteracting movements of structural components which the system is arranged on,
thermal control of receiver and/or laser for increasing the accuracy of the signals and measurements,
movable elliptic mirrors for measuring incoming light in different directions,
movable lenses and other optics for directional control of the laser beam emitting the system,
an aperture for reducing scatter light from other sources which hit the receiver, and/or
a rotating surface, or spherical, parabolic or elliptical mirrors for scanning emitting and incoming light in one or more axes.

26. System according to claim 14, characterized in that the system further includes a control device (11) including one or more of:
microcontroller with internal or external memory,
data logger,
means for external communication with an external panel or surveillance equipment (18), such as a PC, for storing or further analysis of data.

27. System according to claim 26, characterized in that the control device (11) is provided with software and/or algorithms, and one or more reference libraries for analyzing the measurements and recognition/determination of the chemical, and possibly software for creating a spatial image of the chemical spillage and/or depth information of the chemical spillage by mapping an image of reflected light in one or more axes, and/or moving the tunable laser source within the same area.

28. System according to claim 15, characterized in that a rotating window (51) is arranged for letting the laser beam (15) out of the encapsulation and letting reflected radiation (52) in, which rotating window (51) is operated by suitable means, such as a shaft (53) or a bearing around the entire window (51) arranged to an electric motor.

29. System according to claim 28, characterized in that the rotating window (51) is connected to one or more magnets (54) and that a drive shaft (55) is connected to polar magnets (56), which transfer the force to the rotating window (51), between which sets of polar magnets (54, 56) is arranged a window (57) which hermetically seals the interior from the exterior.
